(19) United States
(12) Patent Application Publication
(10) Pub. No.: US 2006/0114197 A1
(43) Pub. Date: Jun. 1, 2006

(54) Lighted display and method

(76) Inventor: Gary Sibbett, Henderson, NV (US)

Correspondence Address: WEISS & MOY PC, 4204 NORTH BROWN AVENUE, SCOTTSDALE, AZ, 85251, US

(21) Appl. No.: 11/331,637

(22) Filed: Jan. 13, 2006

Related U.S. Application Data
(63) Continuation-in-part of application No. 10/835,206, filed on Apr. 29, 2004.

(51) Int. Cl. G09G 3/30

(52) U.S. Cl. 345/76

(57) ABSTRACT

A lighted display device which may be of either the EL or LED type. In the EL embodiment, an EL sheet may be positioned on an upper surface of a driver, and removably secured thereto with an outer snap ring. This configuration would permit changing out of an EL sheet, while still retaining the other device components. In one embodiment, the device utilizes a touch switch, so that illumination will occur when a user touches the EL sheet in proximity to the switch. In another embodiment, the device utilizes a motion sensor, so that movement in proximity to the device will cause illumination.

### RELATED APPLICATIONS

This application claims priority to Ser. No. 10/835,206, filed Apr. 29, 2004 μl the name of the same inventor entitled “MODULAR LIGHTED DISPLAY AND METHOD THEREFOR,” and to Ser. No. 10/835,199, filed Apr. 29, 2004 in the name of the same inventor, entitled “MOUNTABLE ILLUMINABLE DISPLAY.”

### FIELD OF THE INVENTION

This invention relates generally to illuminable displays, and more particularly, to illuminable displays having one or more advantages as compared to the prior art in terms of attachability, flexibility in changing the image of the display, and/or with respect to other features.

### BACKGROUND OF THE INVENTION

Lighted displays; which provide an illuminated design on an otherwise un-illuminated surface have become increasingly popular. Because of the attention attracted by an illuminated sign or design, illuminated displays have found uses in safety equipment, commercial advertisements, personal fashion, and many other applications. Frequently, such devices provide colorful designs and feature additional effects such as a flashing behavior to attract additional attention.

Typically, lighted displays are of an electroluminescence (EL) type or of a light emitting diode (LED) type. EL technology provides the benefits of high efficiency, flexible materials, and providing a plane solid light source. LED displays typically use a colorful surface having one or more LEDs positioned on the surface to attract additional attention, or have one or more LEDs under a translucent film having a design for a back-lighting effect as the LED emits light through the translucent film.

Lighted displays have been mounted on or built into items such as headwear, shoes, jewelry, and promotional-type materials such as coffee mugs and memo pad holders that are typically given away to consumers to promote a product or service. However, items manufactured with displays are limited by only having the capacity for use with the display provided, and manufacturers incur significant costs in designing and manufacturing such displays into each item to be manufactured.

Additionally, lighted displays that are mounted on or built into items by the manufacturer suffer the drawback that the lighted display is not easily removable by the consumer. As a result, the consumer must spend much time or effort to remove or replace the lighted display, such as when it malfunctions. Similarly, articles of clothing having an attached lighted display are not easily washed, as typically the lighted displays are stitched into place and are not waterproof.

Still further, lighted displays are not changeable by a user, in a manner that would change the appearance of the display without requiring a changing out of the entire display hardware.

A need therefore exists to provide a lighted display that overcomes these limitations and disadvantages of present lighted displays. The present invention satisfies these needs, and provides other, related, advantages.

### SUMMARY OF THE INVENTION

In accordance with one embodiment of the present invention, a lighted display device is disclosed. The device comprises: a driver having, an upper surface and a bottom surface and a source of power; an EL sheet adapted to be positioned on the upper Surface of the driver; wherein the EL sheet is in electrical contact with the driver; and an outer snapping ring adapted to be positioned around a peripheral area of the EL sheet and to removably secure the EL sheet to the driver.

In accordance with another embodiment of the present invention, a lighted display device is disclosed. The device comprises: a driver having an upper surface and a bottom surface and a source of power; an EL sheet adapted to be positioned on the upper surface of the driver; wherein the EL sheet is in electrical contact with the driver; and a switch controlling transmission of an electrical signal from the source of power to the EL sheet; wherein the switch is a touch switch.

In accordance with a further embodiment of the present invention, a method for altering the appearance of a lighted display device is disclosed. The method comprises: utilizing a lighted display comprising: a driver having an tipper surface and a bottom surface and a source of power; an EL sheet adapted to be positioned on the upper surface of the driver; wherein the EL sheet is in electrical contact with the driver; and an outer snapping ring adapted to be positioned around a peripheral area of the EL sheet and to removably secure the EL sheet to the driver; positioning a first EL sheet having a first appearance on the tipper surface of the driver; snapping the outer snapping ring in position around a peripheral area of the first EL sheet and the driver; supplying an electrical signal from the source of power to the first EL sheet; removing the outer snapping ring; removing the first EL sheet; positioning a second EL sheet having a second appearance on the upper surface of the driver; snapping the outer snapping ring in position around a peripheral area of the second EL sheet and the driver; and supplying an electrical signal from the source of power to the first EL sheet.

### BRIEF DESCRIPTION OF THE DRAWINGS

FIG. 1 is a top view of an outer snap ring component of a lighted device consistent with an embodiment of the present invention.

FIG. 2 is a top view of an EL sheet component of a lighted device consistent with an embodiment of the present invention.

FIG. 3 is a top view of a back attaching ring component of a lighted device consistent with an embodiment of the present invention.

FIG. 3A is a side view of the back attaching ring of FIG. 3.

FIG. 4 is a top view of a driver component of a lighted device consistent with an embodiment of the present invention.

FIG. 5 is a bottom view of a driver component of a lighted device consistent with an embodiment of the present invention.

FIG. 6 is an exploded view of a lighted device consistent with an embodiment of the present invention.

FIG. 7 is a partial exploded view, illustrating coupling to an object of two components of a lighted device consistent with an embodiment of the present invention.

FIG. 8 is a top view of an assembled lighted device consistent with an embodiment of the present invention.

FIG. 8A is a bottom view of an assembled lighted device consistent with an embodiment of the present invention.

FIG. 9 is a top view of an EL sheet component of a lighted device consistent with an embodiment of the present invention.

FIG. 9A is a bottom view of an EL sheet component of a lighted device consistent with an embodiment of the present invention.

FIG. 10 is a perspective view of an assembled lighted device consistent with an embodiment of the present invention, attached to an article of clothing, with the top portion of the device being visible.

FIG. 10A is a perspective view of an assembled lighted device consistent with an embodiment of the present invention, attached to an article of clothing, with the bottom portion of the device being visible.

FIG. 11 is a front view of an assembled lighted display device consistent with an embodiment of the present invention, configured as a commercial display.

FIG. 11A is a rear view of the assembled lighted display device of FIG. 11.

### DETAILED DESCRIPTION OF THE PREFERRED EMBODIMENTS

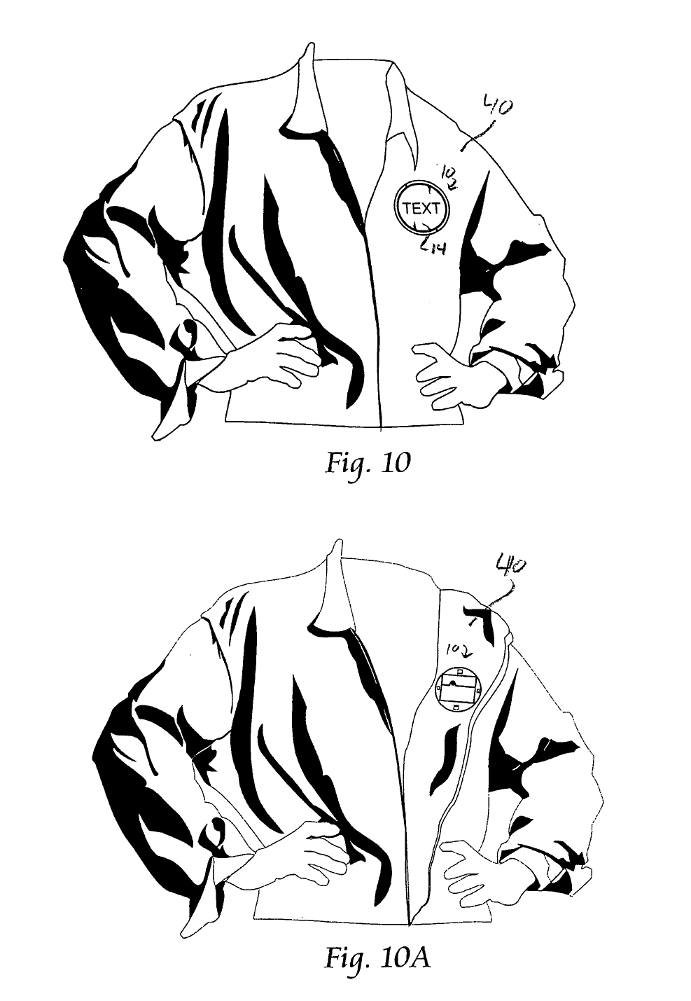

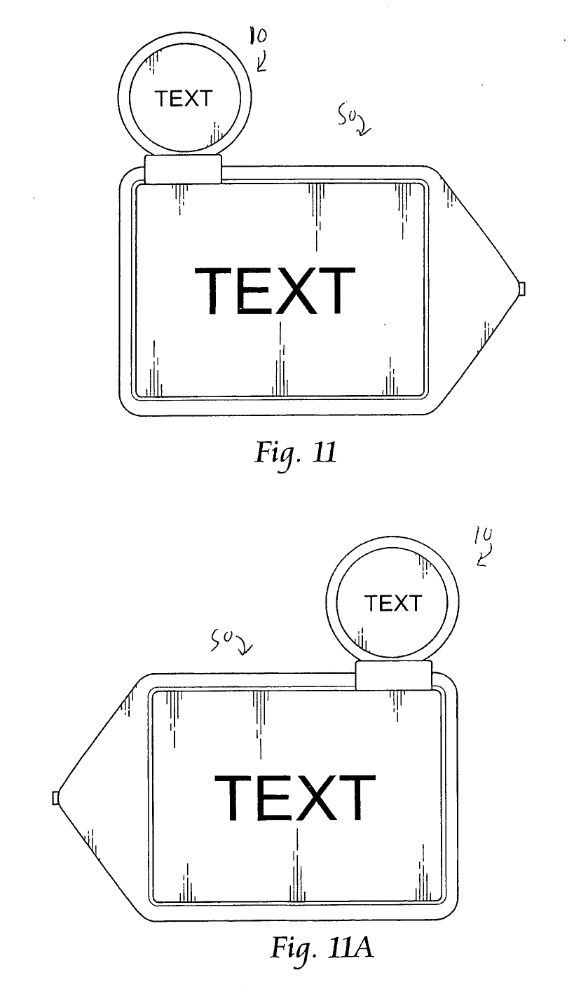

In general, this invention is a lighted device that may be configured as a commercial display (FIGS. 11-11A) or that may be placed on a variety of different objects, including for example a coat (see FIGS. 10-10A), backpack, daytime, cookie jar, lunch box, tote bag, picture frame, stuffed animals, door hangars, book covers, or one or more of the objects disclosed in either or both of the parent applications to this application. Except as specifically described herein, the lighted display device may be of either the EL or LED type.

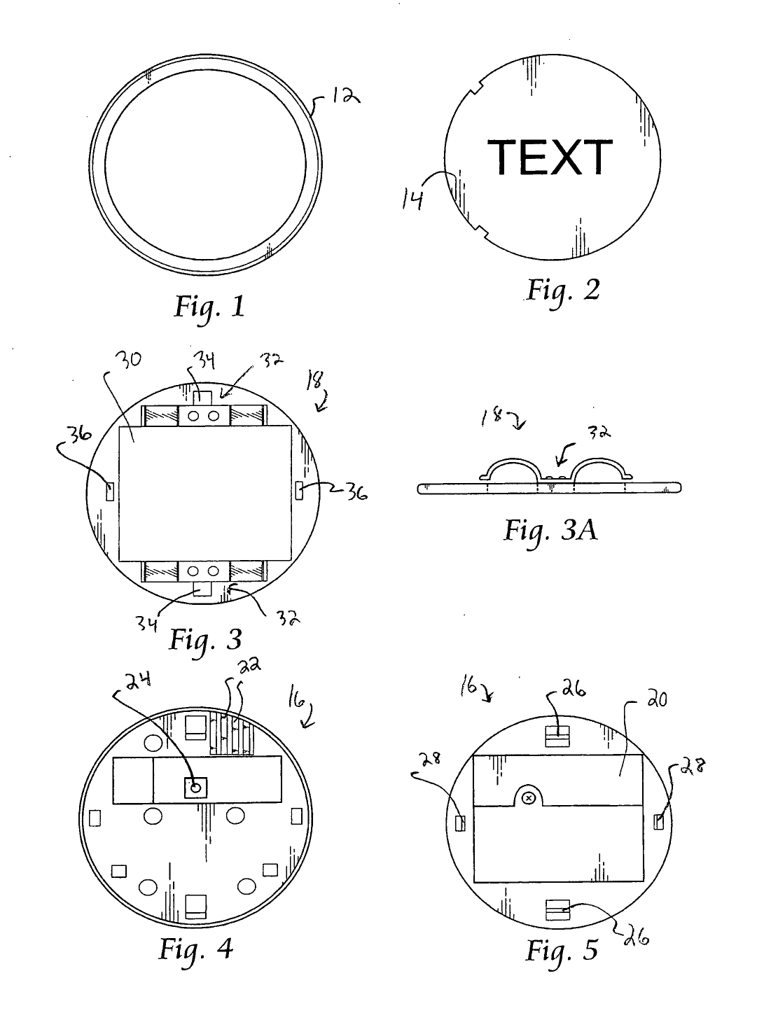

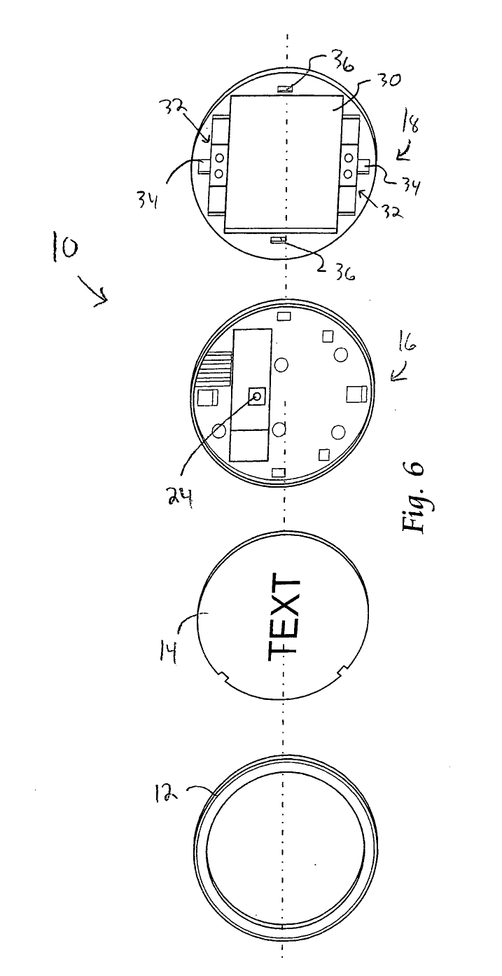

Referring to FIGS. 1-6, components of a lighted device 10 consistent with an embodiment of the present invention are shown. FIGS. 1-5 illustrate individual components of the device 10, and FIG. 6 discloses how the components of FIGS. 1-5 are combined with each other to form the device 10. The main components, as shown in these figures, include an outer snap ring 12 (FIG. 1), an EL sheet 14 (FIG. 2), a driver 16 (FIGS. 4-5) and a back attaching ring 18 (FIG. 3).

The driver 16 contains the power source for the lighted device 10, and provides an electrical signal to the device. The power source may be batteries, which in this embodiment would be positioned within a battery case 20 located on an underside of the driver 16. See FIG. 5. The electrical signal may be communicated to output contacts 22 located on an upper surface of the driver 16. Corresponding input contacts 23 on the bottom surface of the EL sheet 14 (see FIG. 9A) receive the electrical signal from the driver 16 when input contacts 23 and output contacts 22 are brought into contact with each other.

The driver 16 may be activated by a switch 24 which, in this embodiment, is located on an upper surface of the driver 16. The switch 24, in one embodiment, may be a touch switch, which would be activated by a person touching the EL sheet 14 in the general area of the switch 24. In another embodiment, the switch 24 may be coupled with a light detector, so as to be activated when the ambient light reaches a predetermined level. (It should be noted that it may be desired to provide a switch 24 that may alternately be activated either by touch or by ambient light.) In another embodiment, the switch 24 may be coupled with a motion sensor, so as to be activated by movement in proximity to the device 10. The motion sensor embodiment would be particularly useful with respect to the commercial display embodiment illustrated in FIGS. 11 and 11A, discussed in more detail below.

Referring specifically to FIG. 5, which illustrates the bottom surface/underside of the driver 16, attention is directed to alignment pins 26 located above and below the battery case 20, and to tabs 28 located on both sides of the battery case 20. As will hereinafter be described, the pins 26 and tabs 28 facilitate removable coupling between the driver 16 and back attaching ring 18.

Referring now to FIGS. 3 and 3A, attention is directed to the back attaching ring 18. In this embodiment, the back attaching ring includes a battery case passage 30 in a central area thereof. Above and below the battery case passage 30 are springs 32. Above and below the springs 32 are alignment pin openings 34. On both sides of the battery case passage 30 are tab receivers 36.

During assembly of the device 10, the underside of the driver 16 is positioned over the back attaching ring 18. The two components are aligned so that the battery case 20 passes through the battery case passage 30, so that the alignment pins 26 enter the alignment pin openings 34, and so that tabs 28 snap into place within tab receivers 36. As the tabs 28 are being snapped into position, the springs 32 will flex sufficiently to permit such snapping to occur. (To de-couple the driver 16 and back attaching ring 18, the user would grasp the tabs 28, bend them from their locked position, and separate the driver 16 and back attaching ring 18.)

Also as part of the assembly process, the EL sheet 14 will be positioned on the upper surface of the driver 16, with the input contacts 23 contacting the output contacts 22. When properly aligned, the EL sheet 14 is then locked in place with the outer snap ring 12, which snaps over the drivel 16. The coupling between the snap ring 12 and the driver 16 should be sufficiently secure to maintain the EL sheet 14 in place, but should be a removable coupling, so that a user may remove the snap ring 12, replace the EL sheet 14 with a different design, and then re-couple the snap ring 12 to the driver 16.

With respect to the replacability of the EL sheet 14, this is considered to be a significant improvement over the prior art. Where the device 10 is being utilized as a commercial display, for example, it would be possible to replace the EL sheet 14 to advertise different products, different prices, and so forth. Where the device 10 is being used to display a logo for a sports team, for example, it would be possible to change the EL sheet 14 to present a different logo for the same team, a different team logo, or to otherwise change the image presented.

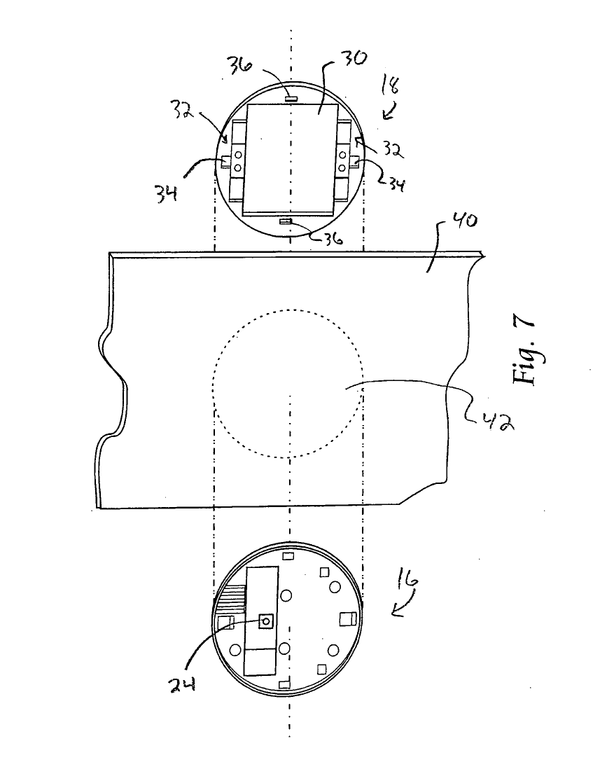

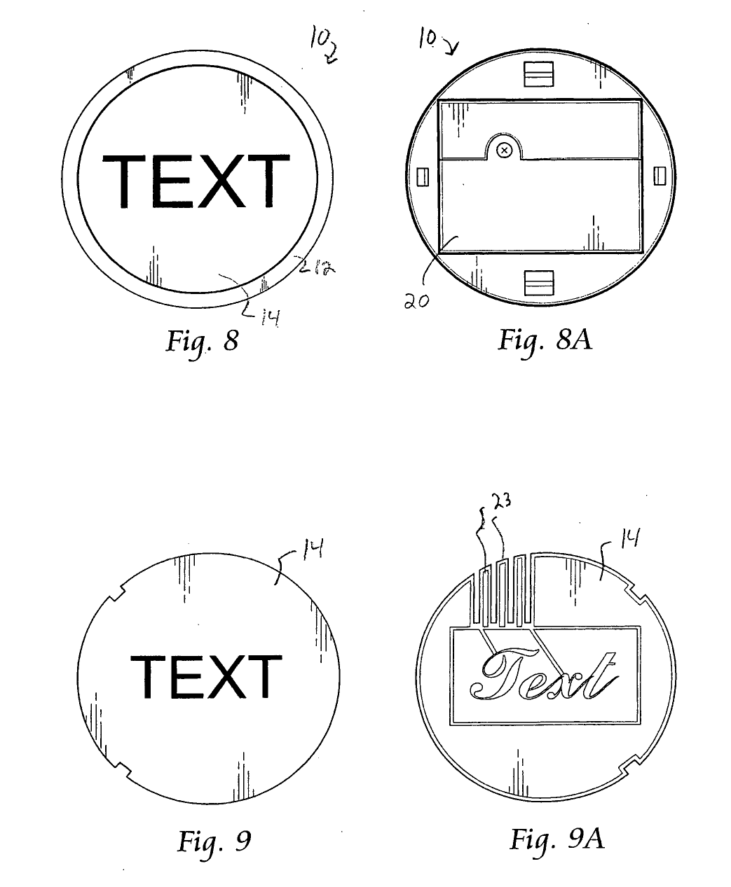

Referring now to FIG. 7, coupling of the device 10 to an object 40 is shown. The object 40 could be essentially any object to which a user may wish to have attached a device 10, including for example any of the products noted above. It should be noted additionally, that the material comprising the object 40 could be of different types and/or thicknesses, including for example, glass, metal, leather, plastic, textile, etc. In this embodiment, an opening 42 is created through the object 40. The opening 40 should be large enough to permit the battery case 20, alignment pins 26, and tabs 28 to pass therethrough, so that the driver 16 may be coupled to the back attaching ring 18 as described above. On the other hand, the opening 42 should have a smaller circumference than the driver 16 and the back attaching ring 18, so that the object 40 may be sandwiched between the driver 16 and the back attaching ring 18.

In one embodiment, the device 10 may be utilized with a variety of objects 40 of varying thicknesses and/or material types. The springs 32 are intended, at least in part, to act as a spacer, and to permit the device 10 to adapt to different thickness and material type objects 40. Where the object 40 is relatively thinner, the springs 32 will flex a relatively larger amount to accommodate the object 40 and still permit coupling between the driver 16 and the back attaching ring 18. Where the object 40 relatively thicker, the springs 32 will need to flex a relatively smaller amount to accommodate that thickness and still permit coupling between the driver 16 and the back attaching ring 18.

As shown in FIGS. 10 and 10A, the object 40 is a jacket. As can be seen from these figures, when in position through opening 42, the battery case 20 passes through to the interior of the object 40, which it may be accessed as needed. The EL sheet 14 is visible on the exterior of the object 40, where it may be viewed.

Referring now to FIGS. 11 and 11A, it can be seen that the device 10 can be combined with a second lighted device 50. The second lighted device 50 may be constructed in like manner to the device 10, and may simply be differently sized and shaped. The configuration shown in FIGS. 11 and 11A is a commercial display. Where the device 10 is to be used as part of a commercial display, whether in combination with a device 50 or by itself, it is preferred that the switch 24 (not shown) be coupled to a motion detector, so that motion in proximity to the device 10 activates it. As seen in these figures, it may be desired to configure the device 10 and second lighted device 50 as two-sided, so that there is a display of lighted text on both sides, to be visible to persons approaching from either side.

In the embodiment shown in FIGS. 11 and 11A, it may be desired to utilize EL technology for purposes of being able to have the benefit of being able to readily change the EL sheet 14, and the text appearing thereon. Alternatively, it may be desired to utilize LED technology.

While the invention has been particularly shown and described with reference to the preferred embodiments thereof, it will be understood by those skilled in the art that the foregoing and other changes in form and details may be made therein without departing from the spirit and scope of the invention.

For example, for certain embodiments, for example the embodiment of FIGS. 11 and 11A, it may be possible to dispense with the back attaching ring 18. The configuration of the springs 32 could be altered in myriad ways, while still permitting variation in the distance between the back attaching ring 18 and driver 16 to accommodate different thickness objects 40. The structure of the coupling means that permits removable coupling of the driver 16 and the back attaching ring 18 could be configured in different ways, as desired, and the means described herein are intended to be exemplary.

I claim:

1. A lighted display device comprising:
a driver having an upper surface and a bottom surface and a source of power;
an EL sheet adapted to be positioned on the upper surface of the driver;
wherein the EL sheet is in electrical contact with the driver; and
an outer snapping ring adapted to be positioned around a peripheral area of the EL sheet and to removably secure the EL sheet to the driver.

2. The lighted display device of claim 1, further comprising a back attaching ring having an upper surface and a bottom surface adapted to be removably coupled to the driver, with the bottom surface of the driver facing the upper surface of the back attaching ring.

3. The lighted display device of claim 1 wherein the source of power is in a battery case projecting outward from the bottom surface of the driver.

4. The lighted display device of claim 3 wherein the back attaching ring includes a battery case passage in a central area thereof, dimensioned to permit passage therethrough of at least a portion of the battery case.

5. The lighted display device of claim 4, further comprising springs projecting upward from the upper surface of the back attaching ring, wherein the springs are adapted to flex when the back attaching ring is coupled to the driver.

6. The lighted display device of claim 4, further comprising:
at least two alignment pin openings on the back attaching ring;
at least two tab openings on the back attaching ring;
at least two alignment pins projecting from the bottom surface of the driver; and
at least two tabs projecting from the bottom surface of the driver;
wherein the at least two alignment pins are adapted to be inserted into the at least two alignment pin openings when the back attaching ring and the driver are coupled together;
wherein the at least two tabs are adapted to be inserted into the at least two tab openings when the back attaching ring and the driver are coupled together.

7. The lighted display device of claim 1 further comprising a switch controlling transmission of an electrical signal from the source of power to the EL sheet and wherein the switch is a touch switch.

8. The lighted display device of claim 1 further comprising a switch controlling transmission of an electrical signal from the source of power to the EL sheet and wherein the switch is coupled to a motion sensor and is activated by motion in proximity to the lighted display device.

9. The lighted display device of claim 1 further comprising a switch controlling transmission of an electrical signal from the source of power to the EL sheet and wherein the switch is coupled to an ambient light sensor and is activated when ambient light reaches a predetermined level.

10. A lighted display device comprising:
a driver having an upper surface and a bottom surface and a source of power;
an EL sheet adapted to be positioned on the upper surface of the driver;
wherein the EL sheet is in electrical contact with the driver; and
a switch controlling transmission of an electrical signal from the source of power to the EL sheet;
wherein the switch is a touch switch.

11. The lighted display device of claim 10, further comprising a back attaching ring having an upper surface and a bottom surface adapted to be removably coupled to the driver, with the bottom surface of the driver facing the upper surface of the back attaching ring.

12. The lighted display device of claim 10 wherein the source of power is in a battery case projecting outward from the bottom surface of the driver.

13. The lighted display device of claim 12 wherein the back attaching ring includes a battery case passage in a central area thereof, dimensioned to permit passage therethrough of at least a portion of the battery case.

14. The lighted display device of claim 13, further comprising springs projecting upward from the upper surface of the back attaching ring, wherein the springs are adapted to flex when the back attaching ring is coupled to the driver.

15. The lighted display device of claim 13, further comprising:
at least two alignment pin openings on the back attaching ring;
at least two tab openings on the back attaching ring;
at least two alignment pins projecting from the bottom surface of the driver; and
at least two tabs projecting from the bottom surface of the driver;
wherein the at least two alignment pins are adapted to be inserted into the at least two alignment pin openings when the back attaching ring and the driver are coupled together;
wherein the at least two tabs are adapted to be inserted into the at least two tab openings when the back attaching ring and the driver are coupled together.

16. A method for altering the appearance of a lighted display device comprising:
utilizing a lighted display comprising:
a driver having an upper surface and a bottom surface and a source of power;
an EL sheet adapted to be positioned on the upper surface of the driver:
wherein the EL sheet is in electrical contact with the driver; and
an outer snapping ring adapted to be positioned around a peripheral area of the EL sheet and to removably secure the EL sheet to the driver;
positioning a first EL sheet having a first appearance on the upper surface of the driver;
snapping the outer snapping ring in position around a peripheral area of the first EL sheet and the driver;
supplying an electrical signal from the source of power to the first EL sheet;
removing the outer snapping ring;
removing the first EL sheet;
positioning a second EL sheet having a second appearance on the upper surface of the driver;
snapping the outer snapping ring in position around a peripheral area of the second EL sheet and the driver; and
supplying an electrical signal from the source of power to the first EL sheet.

17. The method of claim 16 wherein the lighted display device further comprises a switch controlling transmission of an electrical signal from the source of power to the EL sheet and wherein the switch is coupled to a motion sensor and is activated by motion in proximity to the lighted display device and further comprising positioning the lighted display device so as to facilitate activation of the switch by motion in proximity to the lighted display device.

18. The method of claim 16 wherein the first appearance and the second appearance each contain product advertisement information.
